(19) United States
(12) Patent Application Publication
(10) Pub. No.: US 2011/0191120 A1
(43) Pub. Date: Aug. 4, 2011

(54) APPARATUS AND METHOD FOR DELIVERING EMPIRICALLY-SUPPORTED TALK THERAPY

(75) Inventors: MICHAEL B. LASKOFF, New York, NY (US); PETER J. PRAMATARIS, Lindenhurst, NY (US); ESTEBAN A. PANZERI-GLAS, Beccar (AR); MARA L. BABIN, Paradise Valley, AZ (US)

(73) Assignee: ABILTO, LLC, New York, NY (US)

(21) Appl. No.: 12/696,564

(22) Filed: Jan. 29, 2010

(51) Int. Cl. G06Q 50/00; G06Q 10/00; H04N 7/15; G06F 3/14

(52) U.S. Cl. 705/3; 705/2; 348/14.08; 348/E07.083; 715/756

(57) ABSTRACT

Certain embodiments include a system and a method for delivering EST to patients through a standardized, predetermined period of time, manualized program. The method includes receiving information from the patient. The information received from the patient relates to a psychological condition of the patient. The method further includes transmitting the information to a psychotherapeutic practitioner. The psychotherapeutic practitioner includes a licensed therapist and a behavioral coach. Further, the method includes receiving information from the psychotherapeutic practitioner based on the patient's information. The information includes a standardized program of empirically-supported therapy treatment over a predetermined period of time. The method also includes transmitting the information received from the psychotherapeutic practitioner to the patient for delivering empirically-supported therapy to the patient, and controlling a plurality of cameras for providing videoconferencing capabilities between the patient, the licensed therapist, and the behavioral coach.

### BACKGROUND

1. Field

Embodiments of the invention are directed to an apparatus, a method, a system, and a computer program for delivering empirically-supported therapy (EST) to patients through a standardized program of EST treatment over a predetermined period of time.

2. Description of the Related Art

For many years, the field of psychology was dominated by psychoanalysis, a method of psychotherapy originated by Sigmund Freud designed to bring preconscious and unconscious material to consciousness primarily through an analysis of transference and resistance. Psychoanalysis is based on the idea that a patient who gains insight into the origins of his psychological problems will be able to overcome day-to-day problems resulting from his mental illness. These problems may cause dysfunctional relationships, negative thought patterns (for example, paranoia or poor self esteem), unwanted behavior (for example, obsessive compulsive disorders or binge eating), or inhibitions (for example, phobias or panic disorders).

Current psychoanalytical therapies, and the many variations thereof, require multiple weekly sessions of open-ended duration; yet these therapies routinely fail to have clear outlined goals that are related to a desired outcome. These unstructured therapies make the quality and value of the treatment difficult to measure, rendering many of these therapies ineffective for treating mental and behavioral disorders.

EST was developed to encourage an adherence to psychological approaches and techniques that are based on scientific evidence. Through ESTs, many psychotherapeutic practitioners have sought to establish and codify best practices, based on existing evidence, for treating mental and behavioral disorders to remove disablements brought on by the problems associated with mental illness. Studies have demonstrated that ESTs produce desirable results for a substantial proportion of clients/patients.

The most common and best-studied EST is cognitive behavioral therapy (“CBT”). A psychotherapeutic practitioner using CBT endeavors to assist a patient/client to overcome his psychological problems by focusing on his recurring counterproductive thoughts (for example, cognition) and recurring counterproductive behaviors and inhibitions. CBT has been proven effective in managing behavioral disorders (for example, panic disorders, phobias, and depression).

The success of current EST techniques is based on (1) the patient/client completing a series of timely exercises or journals between sessions with his therapist, and (2) the licensed practitioner (or therapist), guiding the treatment, to strictly adhere to a particular EST program. Deviation from a proscribed EST methodology can compromise the ability of the licensed practitioner to measure the patient's/client's progress, which is antithetical to the practice of ESTs. As a result, current EST systems fail to assist clients/patients having psychological problems.

### SUMMARY

In accordance with an embodiment of the invention, there is provided an apparatus for delivering empirically-supported therapy to a patient. The apparatus includes a controller, and a receiver configured to receive information from the patient. The information received from the patient relates to a psychological condition of the patient. The apparatus further includes a transmitter configured to transmit the information received from the patient to a psychotherapeutic practitioner. The psychotherapeutic practitioner includes a licensed therapist and a behavioral coach. The receiver is further configured to receive information from the psychotherapeutic practitioner based on the patient's information. The information received from the psychotherapeutic practitioner includes a standardized program of empirically-supported therapy treatment over a predetermined period of time. The transmitter is further configured to transmit the information received from the psychotherapeutic practitioner to the patient for delivering empirically-supported therapy to the patient. The controller is configured to control a plurality of cameras to provide videoconferencing capabilities between the patient, the licensed therapist, and the behavioral coach.

In accordance with another embodiment of the invention, there is provided an apparatus for empirically-supported therapy to a patient. The apparatus is configured to receive information from the patient. The information received from the patient relates to a psychological condition of the patient. The apparatus is further configured to transmit the information received from the patient to a psychotherapeutic practitioner. The psychotherapeutic practitioner includes a licensed therapist and a behavioral coach. Further, the apparatus is configured to receive information from the psychotherapeutic practitioner based on the patient's information. The information received from the psychotherapeutic practitioner includes a standardized program of EST treatment over a predetermined period of time. The apparatus is further configured to transmit the information received from the psychotherapeutic practitioner to the patient for delivering empirically-supported therapy to the patient, and control a plurality of cameras to provide videoconferencing capabilities between the patient, the licensed therapist, and the behavioral coach.

In accordance with another embodiment of the invention, there is provided a method for delivering empirically-supported therapy to a patient. The method includes receiving information from the patient. The information received from the patient relates to a psychological condition of the patient. The method further includes transmitting the information received from the patient to a psychotherapeutic practitioner. The psychotherapeutic practitioner includes a licensed therapist and a behavioral coach. Further, the method includes receiving information from the psychotherapeutic practitioner based on the patient's information. The information includes a standardized program of EST treatment over a predetermined period of time. The method also includes transmitting the information received from the psychotherapeutic practitioner to the patient for delivering EST to the patient, and controlling a plurality of cameras for providing videoconferencing capabilities between the patient, the licensed therapist, and the behavioral coach.

In accordance with another embodiment of the invention, there is provided a computer program embodied on a computer readable medium. The computer program is configured to control a processor to perform a process. The process includes receiving information from the patient. The information received from the patient relates to a psychological condition of the patient. The process further includes transmitting the information received from the patient to a psychotherapeutic practitioner. The psychotherapeutic practitioner includes a licensed therapist and a behavioral coach. Further, the process includes receiving information from the psychotherapeutic practitioner based on the patient's information. The information includes a standardized program of EST treatment over a predetermined period of time. The process also includes transmitting the information received from the psychotherapeutic practitioner to the patient for delivering empirically-supported therapy to the patient, and controlling a plurality of cameras for providing videoconferencing capabilities between the patient, the licensed therapist, and the behavioral coach.

### BRIEF DESCRIPTION OF THE DRAWINGS

For proper understanding of the invention, reference should be made to the accompanying drawings, wherein:

FIG. 1 illustrates an apparatus implementing, at least, the method illustrated in FIG. 3, of an EST system, in accordance with an embodiment of the invention.

FIG. 2 illustrates a processor for delivering EST to a patient, in accordance with an embodiment of the invention.

FIG. 3 illustrates a method for delivering EST to a patient, in accordance with an embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of an apparatus, a method, a system, and a computer program, as represented in the attached figures, is not intended to limit the scope of the invention as claimed, but is merely representative of selected embodiments of the invention.

Certain embodiments of the invention combine hardware and software components to create an apparatus, a method, a system, and a computer program for delivering EST to a patient. In particular, certain embodiments of the invention provide an apparatus, a method, a system, and a computer program for delivering EST to patients through a standardized program of EST treatment over a predetermined period of time. The EST program has been manualized and is administered to patients through an electronic forum by an integrated team of psychotherapeutic practitioners including, at least, a licensed therapist and a behavioral coach.

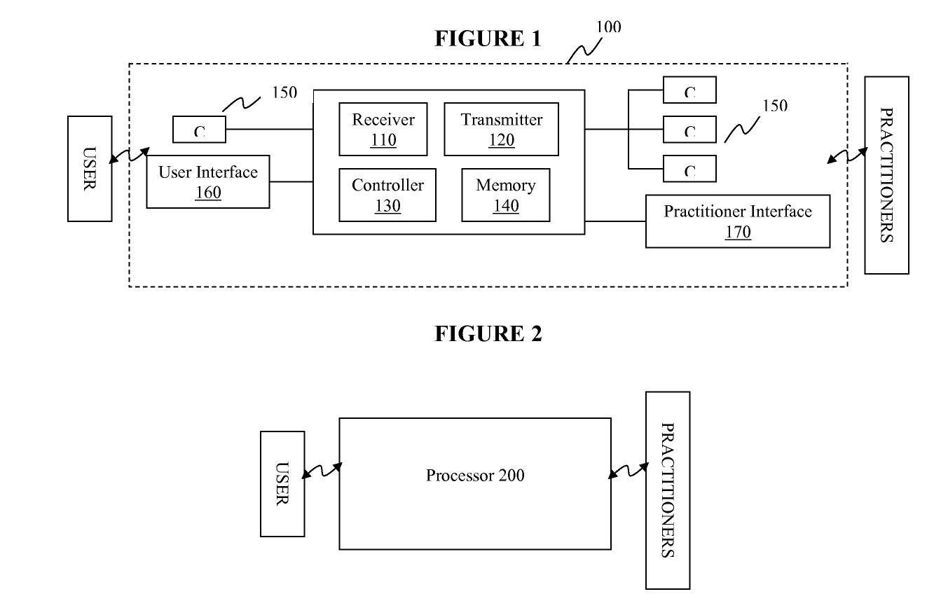

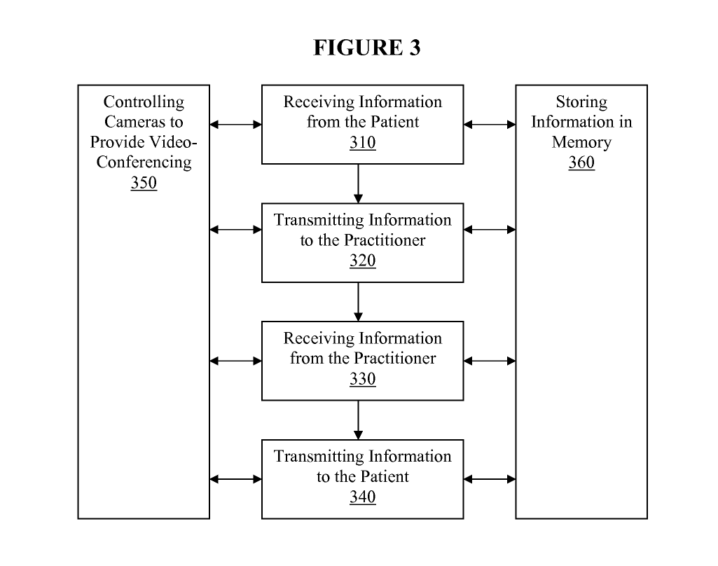

FIG. 1 illustrates an apparatus 100 implementing, at least, the method illustrated in FIG. 3, of an EST system, in accordance with an embodiment of the invention. The apparatus may include a receiver 110, a transmitter 120, a controller 130, a memory 140, a plurality of cameras 150, a patient interface 160, and a practitioner interface 170.

The receiver 110 may be configured to receive information that has been entered by an individual having a psychological condition (“patient”) using the patient interface 160. The transmitter 120 may be configured to transmit the patient's information to a psychotherapeutic practitioner through the practitioner interface 170. The psychotherapeutic practitioner may include, for example, an intake specialist, a licensed therapist, a behavioral coach, and a supervising consultant. Each of these psychotherapeutic practitioners may be licensed in his respective state jurisdiction, for example, a psychologist licensed by the California Board of Psychology. The behavioral coach may include an individual who assists a patient with identifying, examining, and adjusting thoughts and beliefs, develop productive behaviors, and become more skilled at emotional management. The behavioral coach, in collaboration with the licensed therapist, may assist the patient with becoming his own coach for tackling present and future challenges

The licensed therapist may perform the following functions: teach didactic elements of the EST to the patient, assign exercises to be completed by the patient between therapy sessions, review completed exercises, and assist the patient with completing program objectives. The role of the behavioral coach may depend on the EST program being administered to the patient. The behavioral coach may perform the following functions: ensure that the patient completes the exercises assigned by the licensed therapist on a timely basis, which may require the behavioral coach to complete the exercises with the patient, and help the patient translate the didactic aspects of the EST into real world actions that can be practically implemented. Some behavioral coaches possess a skill set that complements the work of the licensed therapist, for example, the behavioral coach may have been trained to teach study and organization skills to a patient having ADHD. However, behavioral coaches do not perform therapy.

The supervising consultant may be a licensed therapist who performs the following functions: observes the work of the licensed therapist and the behavioral coach on a periodic basis, provides recommendations regarding ways that patient service may be enhanced, monitors that the behavioral coach is not performing therapy, evaluates the performance of the licensed therapist and the behavioral coach, and resolves conflicts that may arise between the licensed therapist and the behavioral coach during the process of administering the EST program.

Further, the receiver 110 may be configured to receive information from the licensed therapist and the behavioral coach based on the patient's entered information. The transmitter 120 may further be configured to transmit the information received from the licensed therapist and the behavioral coach through the patient interface 160 to deliver the EST program to the patient.

The information received from the licensed therapist and the behavioral coach may include a standardized program of EST treatment that may be administered over a predetermined period of time.

A memory 140 may include a database configured to store the information received from the patient and transmitted to the psychotherapeutic practitioner, the information received from the psychotherapeutic practitioner based on the patient's information and transmitted to the patient, the standardized EST program (stored in the form of a manual or set of manuals), a common chart, and process notes.

The common chart may include the information entered by the patient during the intake process, treatment information, patient attendance, raw data and notes recorded by the psychotherapeutic practitioners during the duration of the EST program. The common chart may be securely retained in the memory 140 for a period of time, for example, ten years, following the conclusion of the EST program. The process notes may include notes generated and shared by the licensed therapist, the behavioral coach, and the supervising consultant. The process notes may be recorded in the memory 140 in fields of the database that are separate from the common chart. The information in the process notes may be securely retained for a period of time, for example, six months, following the conclusion of the EST program.

The patient information stored in the memory 140 may be used to manually or electronically analyze the progress of the patient and the effectiveness of the EST in treating the patient's psychological condition. The memory 140 also may allow the patient information to be aggregated with other patients' information for evaluating metrics of the system and the performance of the psychotherapeutic practitioners. Using the information stored in the memory 140, empirically-supported improvements may be made to eliminate ineffective methods and to develop best practices for current EST programs.

The information received from the patient and transmitted to the psychotherapeutic practitioners may include information related to a psychological condition of the patient, and may further include two types of quantifiable information. The first type may include a questionnaire, for example, a beck depression inventory (“BDI”) or BDI-II, or similar multiple-choice questionnaire, that measures a severity of depression that the patient may be experiencing as a result of his psychological condition. The questionnaire may help a psychotherapeutic practitioner determine how likely the individual, as a potential patient, may be in harming himself or others, so that he can be referred to a more appropriate resource, if necessary. The second type of quantifiable information may be derived from a standardized battery of tests completed by a patient to assess the suitability of a selected EST program and the likely benefit that the patient may receive as a result of being treated by the selected EST program.

The information received from the patient and transmitted to the psychotherapeutic practitioners may also include responses to questions presented by the intake specialist during an initial consultation with the patient. The questions may be associated with a structured diagnostic interview, for example, the Mini-International Neuropsychiatric Interview (M.I.N.I.). M.I.N.I. is a structured diagnostic interview that has been developed by psychiatrists and clinicians in the United States and Europe for diagnostic and statistical manual of mental disorders (e.g., DSM-IV) and the international classification of psychiatric disorders (e.g., ICD-10). Based on the patient's answers, the intake specialist may be able to determine whether the patient should be referred to the licensed therapist and the behavioral coach for EST, or whether the patient should be referred to a more appropriate resource to address the patient's needs.

Suitability of the patient for EST by the licensed therapist and the behavioral coach may be determined using four criteria. For example, the prospective patient must first initiate the intake process himself. The intake process may require the patient to provide personal information, for example, age, address, payment information (e.g., credit or debit card information). As previously described, the prospective patient may further be required to answer a questionnaire, for example, a BDI or BDI-II, or similar multiple-choice questionnaire, that measures a severity of depression that the patient may be experiencing as a result of his psychological condition. The questionnaire may permit the intake specialist to determine how likely the individual, as a potential patient, may be in harming himself or others, so that he can be referred to a more appropriate resource, if necessary. Based on the collected information, the intake specialist may subjectively determine whether the prospective patient meets the criteria of individuals who have benefited from the EST program. This collected information may be supplemented with information provided by the intake specialist during an interview portion of the initial consultation. The interview may be conducted using the plurality of cameras 150, or via other communications, for example, email or telephone.

If the intake specialist determines that the patient is not suitable for EST, the intake specialist may refer the patient to other resources based on geographic (in-state resources) or issue-specific (national or web-based resources) resources. Emergency services may also be available to the intake specialist.

If the intake specialist determines that the patient is suitable for EST, the intake specialist may create the common chart, which is made available to the licensed therapist, the behavioral coach, and the supervising consultant.

Further, the information received from the patient and transmitted to the psychotherapeutic practitioner may include the patient's response to exercises assigned to the patient as part of the EST program.

The information received from the psychotherapeutic practitioner and transmitted to the patient may include the information presented by the intake specialist to the prospective patient as part of the intake process, as described above. The information may also include a standardized script of information to assist the intake specialist with verifying the information submitted by the patient during the pre-consultation phase. The standardized script may facilitate an objective determination of whether the individual is a patient suitable for EST. The information may further include consent forms that must be executed by the patient prior to providing the patient with access to EST. The consent forms are necessary to protect the other psychotherapeutic practitioners' use of the patient's information under HIPAA regulations and other privacy laws.

The information received from the licensed therapist and the behavioral coach may include, for example, defined objectives, exercises, provider scripts, quantitative data capture fields (common chart), qualitative data capture fields (common chart), and data capture fields for the process notes. The defined objectives, exercises, and provider scripts may be transmitted to the patient, while the quantitative data capture fields (common chart), qualitative data capture fields (common chart), and data capture fields for the process notes may be stored in the memory 140.

The EST program may include a proven, empirically-supported approach that has been described in peer-reviewed academic literature. The EST program may further include a set of defined objectives for a defined population and a set of specific, validated measures to assess outcomes and the effectiveness of the program on a patient's psychological condition. The objectives of the program may be quantifiable, for example, panic disorder programs may include a goal of substantially reducing or eliminating an incidence of panic and extending a period of time between panic attacks. For example, in a case of an attention deficit hyperactivity disorder (ADHD) treatment program, an objective may include the capacity to track an effectiveness of the program based on an increase or decrease in the patient's academic grade point average. An example of an ADHD program, as provided for an embodiment of the invention, is provided in Appendix A.

The EST program may further include, for example, four types of programs, an initial program, a continuing program for individuals, a continuing program for groups, and a subscription. The initial program may include a peer-reviewed, empirically-supported program, generally of a predetermined period of time of, for example, 10 weeks. The initial program may offer a patient one therapy session with the licensed therapist and one counseling session with the behavioral coach per week. Prospective patients must complete an intake process with the intake specialist prior to commencing this program. The initial program may further include, for example, a EST program for overcoming ADHD, panic disorders, sexual identity, post-traumatic stress disorders, or insomnia, and for managing predictable life transitions, such as school-work, single-relationship, or the arrival of a first child. The initial program may include three primary components: assessment & stabilization, insights & skills and consolidation & transition. The assessment & stabilization component of the initial program may help to ensure that the patient and the psychotherapeutic practitioners understand the totality of the immediate issue surrounding the patient's psychological condition to be addressed, and may further help the psychotherapeutic practitioners take short-term actions that will allow for rapid crisis resolution. The insights & skills component of the initial program may help the patient to understand his behavioral disablement(s) and learn skills to address and overcome them with the help of the psychotherapeutic practitioners and the standardized EST program. The consolidation & transition component of the initial program may help the patient to consolidate his gains and create the appropriate transition/separation for him at the end of the program. During this period, the psychotherapeutic practitioners may attempt to address any areas of continuing weakness. At this point in the initial program, the psychotherapeutic practitioners may also recommend continuing programs or alternative forms of therapeutic intervention for the patient.

The continuing program for individuals may include a program that is suited for individuals who have completed the initial program, and elect to sign up for a less intensive, 10-week program. The continuing program may not require the intake process, and may offer less therapy sessions and counseling sessions than the initial program, but at a reduced price. The continuing program allows the patient to consolidate advances made in the initial program and to develop new skills.

The continuing program for groups may include a program similar to the continuing program for individuals previously described, except that the patient participates in a group session on a weekly basis, for example, over a predetermined period of time. Groups may include up to five patients and may be conducted by the licensed therapist and supported by the behavioral coach. The behavioral coach may also provide additional support on a one-on-one basis throughout the week. Continuing programs for groups may last for a predetermined period of time, for example, 10 weeks, and may be less expensive than the continuing program for individuals.

The subscription may permit a patient, who has completed the initial program, to pay a monthly fee for access to a predetermined amount of services on a monthly basis with no predetermined period of time. The subscription may be effective for individuals who are seeking a quality-assured and convenient alternative to long-term support groups.

The controller 130 may further be configured to distribute each of the standardized EST programs (in the form of manuals) in real time to the patient, the licensed therapist, the behavioral coach, and the supervising consultant. Data from the manuals may be made available to a respective party based on his need/role and only at required times. The controller 130 may also be configured to capture the data or information input by the patient, the licensed therapist, the behavioral coach, and the supervising consultant.

One of the plurality of cameras 150 may be configured at the patient interface 160, and at least one of the plurality of cameras 150 may be configured at the practitioner interface 170. The controller 130 may be configured to control each of the plurality of cameras 150 for delivering videoconferencing capabilities between the patient, the licensed therapist, the behavioral coach, and any other psychotherapeutic practitioners that may be interacting with the patient.

Each of the plurality of cameras 150 may include an Internet, web-based camera that provides interactive telecommunications technologies, such as video chat, allowing the patient and the psychotherapeutic practitioners the ability to interact simultaneously with one another via two-way video and audio transmissions. The plurality of cameras 150 configured at the patient interface 160 and the practitioner interface 170 may allow the intake specialist to conduct the intake process, the licensed therapist to conduct therapy sessions, the behavioral coach to conduct coaching sessions, and the supervising consultant to observe the work of the psychotherapeutic practitioners with the patient.

The patient interface 160 and the practitioner interface 170 may include any microprocessor or processor controlled device that permits access to the Internet, including terminal devices, for example, personal computers, workstations, servers, clients, mini computers, main-frame computers, laptop computers, a network of individual computers, mobile computers, palm-top computers, hand-held computers, interactive televisions, interactive kiosks, personal digital assistants, interactive wireless communications devices, mobile browsers, or a combination thereof. The patient interface 160 and the practitioner interface 170 may further include input devices, for example, a keyboard, mouse, touchpad, joystick, pen-input-pad, output devices, for example, a computer screen and a speaker, fingerprint readers, touchscreens, label printers, and the like.

The patient interface 160 may include a single interface that is configured to allow the patient to enter information about the patient's psychological condition, as previously described, through a webpage. The patient interface 160 may also be configured to receive information from the psychotherapeutic practitioners via the controller 130, as previously described.

The practitioner interface 170 may include a single interface or a plurality of interfaces to allow the psychotherapeutic practitioners (e.g., the intake specialist, the licensed practitioner, the behavioral coach, and the supervising consultant) to view the patient's information. The intake specialist, the licensed practitioner, the behavioral coach, and the supervising consultant may each use the practitioner interface 170 to perform specific tasks for the administration of the EST program, as previously described (i.e., for referring the individual as a patient to the licensed therapist and the behavioral coach, for transmitting a selected EST program to the patient, for helping the patient complete the standardized EST program, and for coaching the patient through the standardized EST program).

FIG. 2 illustrates a processor for delivering EST to a patient, in accordance with an embodiment of the invention. The processor 200 can be configured to perform the functionality of all the structural elements, the receiver 110, the transmitter 120, the controller 130, the memory 140, and the plurality of cameras 150, the patient interface 160, and the practitioner interface 170, as described above.

FIG. 3 illustrates a method for delivering EST to a patient, in accordance with an embodiment of the invention. The method may include receiving, by the receiver 110, information from an individual having a psychological condition (e.g., a patient) (step 310). The information received from the patient may relate to the psychological condition of the patient. The method may further include transmitting, by the transmitter 120, the information to a psychotherapeutic practitioner (step 320). The psychotherapeutic practitioner may include, for example, an intake specialist, a licensed therapist, a behavioral coach, and a supervising consultant, and more preferably may include, at least, the licensed therapist and the behavioral coach. Each of these psychotherapeutic practitioners may be licensed in his respective state jurisdiction, for example, a psychologist licensed by the California Board of Psychology. The functions of the licensed therapist, the behavioral coach and the supervising consultant were previously described in relation to FIG. 1.

Information may be received, by the receiver 110, from the psychotherapeutic practitioner based on the patient's information (step 330). Receiving, by the receiver 110, information from the psychotherapeutic practitioner may include receiving information from the intake specialist. The information received from the intake specialist may include a standardized script of information to assist the intake specialist with verifying the information submitted by the patient during the pre-consultation phase. The standardized script may facilitate an objective determination of whether the individual is a patient suitable for EST. The information may further include consent forms that must be executed by the patient prior to providing the patient with access to EST. The consent forms are necessary to protect the other psychotherapeutic practitioners' use of the patient's information under HIPAA regulations and other privacy laws.

Suitability of the patient for EST by the licensed therapist and the behavioral coach may be determined using four criteria. For example, the prospective patient must first initiate the intake process himself. The intake process may require the patient to provide personal information, for example, age, address, payment information (e.g., credit or debit card information). As previously described, the prospective patient may further be required to answer a questionnaire, for example, a BDI or BDI-II, or similar multiple-choice questionnaire, that measures a severity of depression that the patient may be experiencing as a result of his psychological condition. The questionnaire may permit the intake specialist to determine how likely the individual, as a potential patient, may be in harming himself or others, so that he can be referred to a more appropriate resource, if necessary. Based on the collected information, the intake specialist may subjectively determine whether the prospective patient meets the criteria of individuals who have benefited from the EST program. This collected information may be supplemented with information provided by the intake specialist during an interview portion of the initial consultation. The interview may be conducted using a plurality of cameras, or via other communications, for example, email or telephone.

If the intake specialist determines that the patient is not suitable for EST, the intake specialist may refer the patient to other resources based on geographic (in-state resources) or issue-specific (national or web-based resources) resources. Emergency services may also be available to the intake specialist.

If the intake specialist determines that the patient is suitable for EST, the intake specialist may create the common chart, which is made available to the licensed therapist, the behavioral coach, and the supervising consultant.

Receiving, by the receiver 110, information from the psychotherapeutic practitioner may include receiving information from the licensed therapist and the behavioral coach based on the patient's information. The information received from the licensed therapist and the behavioral coach may include a standardized program of EST treatment that may be administered over a predetermined period of time. Receiving, by the receiver 110, information from the psychotherapeutic practitioner may also include receiving, for example, defined objectives, exercises, provider scripts, quantitative data capture fields (common chart), qualitative data capture fields (common chart), and data capture fields for the process notes. The defined objectives, exercises, and provider scripts may be transmitted to the patient, while the quantitative data capture fields (common chart), qualitative data capture fields (common chart), and data capture fields for the process notes may be stored in a memory.

The EST may include a proven, empirically-supported approach that has been described in peer-reviewed academic literature. The EST program may further include a set of defined objectives for a defined population and a set of specific, validated measures to assess outcomes and the effectiveness of the program on a patient's psychological condition. The objectives of the program may be quantifiable, for example, panic disorder programs may include a goal of substantially reducing or eliminating an incidence of panic and extending a period of time between panic attacks. For example, in a case of an attention deficit hyperactivity disorder (ADHD) treatment program, an objective may include the capacity to track an effectiveness of the program based on an increase or decrease in the patient's academic grade point average. An example of an ADHD program, as provided for an embodiment of the invention, is provided in Appendix A.

The EST program may further include, for example, four types of programs, an initial program, a continuing program for individuals, a continuing program for groups, and a subscription, as previously described in relation to FIG. 1.

Further, the method may include transmitting, by the transmitter 120, the information received from the psychotherapeutic practitioner to the patient for delivering EST to the patient (step 340). As previously described, each of the licensed therapist and the behavioral coach have specific responsibilities in administering the EST program to the patient. Therefore, information may be received from the licensed therapist and the behavioral coach to effectively facilitate the administration of the EST program.

The method may further include controlling, by the controller 130, a plurality of cameras for providing videoconferencing capabilities between the patient, the licensed therapist, the behavioral coach, and any other psychotherapeutic practitioners that may be interacting with the patient (step 350). One of the plurality of cameras may be configured at a patient interface, and at least one of the plurality of cameras may be configured at a practitioner interface. Each of the plurality of cameras may include an Internet, web-based camera that provides interactive telecommunications technologies, such as video chat, allowing the patient and the psychotherapeutic practitioners the ability to interact simultaneously with one another via two-way video and audio transmissions.

Accordingly, the plurality of cameras configured at the patient interface and the practitioner interface may allow the intake specialist to conduct the intake process, the licensed therapist to conduct therapy sessions, the behavioral coach to conduct coaching sessions, and the supervising consultant to observe the work of the psychotherapeutic practitioners with the patient.

The method may further include storing, by the memory 140, the information received from the patient and transmitted to the psychotherapeutic practitioner, the information received from the psychotherapeutic practitioner based on the patient's information and transmitted to the patient, the standardized EST program (stored in the form of a manual or set of manuals), a common chart, and process notes in a memory or database (step 360). The patient information, practitioner information, the EST program, the common chart and the process notes were previously discussed in relation to FIG. 1. The memory or the database may allow the patient information to be aggregated with other patients' information for evaluating metrics of the system and the performance of the psychotherapeutic practitioners. Using the information stored in the memory or the database, empirically-supported improvements may be made to eliminate ineffective methods and to develop best practices for current EST programs.

Storing, by the memory 140, may include distributing standardized EST programs (in the form of manuals) in real time to the patient, the licensed therapist, the behavioral coach, and the supervising consultant. Data from the manuals may be made available to a respective party based on his need/role and only at required times. Storing, by the memory 140, may also include capturing the data or information input by the patient, the licensed therapist, the behavioral coach, and the supervising consultant into the patient interface or the practitioner interface.

In another embodiment of the invention, a computer program embodied on a computer readable medium is provided. The computer program can be configured to control a processor to perform at least the method described in FIG. 3.

The steps of the method described in connection with the embodiments disclosed herein can be embodied directly in hardware, in a computer program executed by a processor, or in a combination of the two. The computer program can be embodied on a computer readable medium, such as a storage medium. For example, a computer program can reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. The storage medium can be coupled to the processor such that the processor can read information from, and write information to, the storage medium. In the alternative, the storage medium can be integral to the processor. The processor and the storage medium can reside in an application specific integrated circuit (ASIC). In the alternative, the processor and the storage medium can reside as discrete components.

Some of the many advantages of embodiments of the invention provide for the standardization of empirically-supported EST, whereby an integrated team of psychotherapeutic practitioners administers the EST for helping a patient overcome a behavioral disablement caused by a prevalent and treatable mental disorder or life transition. Standardization permits the systematic implementation of proven, empirically-supported best practices, while reducing a dependence on a particular provider. Furthermore, embodiments of the invention allow patient and provider performance and the efficacy of EST programs to be quantifiably evaluated and improved upon.

Embodiments of the invention provide EST that is effective in treating a growing number of mental and behavioral disorders. In contrast to psychoanalytical approaches, EST tends to produce effective results with a limited number of sessions conducted over a finite period of time, for example, twelve weeks or less. EST, as delivered by an embodiment of the invention, provides outcomes that are easier to predict, measure, and verify, demonstrating the effectiveness of EST's empirically-supported foundation.

The integration of a behavioral coach into the team of psychotherapeutic practitioners may reduce the amount of time required between therapy sessions and improve the progress of the patient's mental health by ensuring that ‘homework’ exercises are completed in a timely fashion and by applying the skill set of the behavioral coach to the improvement of the patient's mental health.

The integration of the consulting supervisor facilitates a monitoring of quality, ensuring that meaningful team collaboration is occurring and making recommendations to improve the patient's progress.

Embodiments of the invention provide pre-determined measurable objectives defined for the patient and the team of psychotherapeutic practitioners, require each licensed therapist and behavioral coach to adhere strictly to the EST program manual in the treatment of every patient, provide credible and consistent methods for gathering data, and promote the use of data to make supportable performance assessments about the benefit of the EST program for the particular patient and the relative effectiveness of the provider and the team of psychotherapeutic practitioners, enhancing quality measures of the EST program for the patient.

Accordingly, although each individual provider will impact the outcome of the service, the aforementioned features of the EST system, as defined by embodiments of the invention, minimize variation and effectiveness of each EST program. Each individual psychotherapeutic practitioner may be recruited with the appropriate education, licensing (if applicable), background, technology skills and attitude. Training may be provided for each of the psychotherapeutic practitioners, and feedback may be provided by the supervising consultant to the licensed therapist and the behavioral coach for improving performance and maximizing consistency of application for each patient.

The features, structures, or characteristics of the invention described throughout this specification may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the relevant art will readily understand that the invention as described above may be practiced with steps in a different order, and/or with hardware elements in configurations which are different than those which are disclosed. The embodiments described above may be practiced or applied independently or may be combined in any appropriate manner. Therefore, although the invention has been described based upon these embodiments, it would be apparent to those of skill in the art that certain modifications, variations, and alternative constructions would be apparent, while remaining within the spirit and scope of the invention.

We claim:

1. An apparatus for delivering empirically-supported therapy to a patient, the apparatus comprising:
a controller;
a receiver configured to receive information from the patient, wherein the information received from the patient relates to a psychological condition of the patient; and
a transmitter configured to transmit the information received from the patient to a psychotherapeutic practitioner, wherein the psychotherapeutic practitioner comprises a licensed therapist and a behavioral coach,
wherein the receiver is configured to receive information from the psychotherapeutic practitioner based on the patient's information,
wherein the information received from the psychotherapeutic practitioner comprises a standardized program of empirically-supported therapy treatment over a predetermined period of time,
wherein the transmitter is configured to transmit the information received from the psychotherapeutic practitioner to the patient for delivering empirically-supported therapy to the patient, and
wherein the controller is configured to control a plurality of cameras to provide videoconferencing capabilities between the patient, the licensed therapist, and the behavioral coach.

2. The apparatus of claim 1, further comprising:
a memory,
wherein the memory is configured to store at least one of the information received from the patient, the information received from the psychotherapeutic practitioner, the standardized program of empirically-supported therapy treatment, a chart of patient information, and a set of notes taken by the psychotherapeutic practitioner.

3. The apparatus of claim 1, wherein the standardized program of empirically-supported therapy treatment comprises the predetermined period of time of no more than twelve weeks.

4. The apparatus of claim 1, wherein the psychotherapeutic practitioner further comprises an intake specialist and a supervising consultant.

5. The apparatus of claim 1, wherein the controller is further configured to analyze a progress of the patient to determine a quality measurement of a performance of the psychotherapeutic practitioner and of an effectiveness of the empirically-supported therapy on the patient.

6. The apparatus of claim 5, wherein the controller is further configured to recommend an adjustment to the performance of the psychotherapeutic practitioner and to the empirically-supported therapy based on the quality measurement for improving the efficacy of the patient's treatment.

7. The apparatus of claim 1, wherein the controller is further configured to distribute the standardized program of empirically-supported therapy treatment that has been manualized to at least one of the patient, the licensed therapist, the behavioral coach, an intake specialist, and a supervising consultant.

8. The apparatus of claim 1, further comprising:
a patient interface configured to allow the patient to enter information about the patient's psychological condition and to complete exercises associated with the standardized program of empirically-supported therapy treatment; and
a practitioner interface configured to allow the psychotherapeutic practitioner to view the patient's information and to provide information associated with the standardized program of empirically-supported therapy treatment to the patient,
wherein the patient interface and the practitioner interface comprise a web-based tool.

9. The apparatus of claim 1, wherein the standardized program of empirically-supported therapy treatment comprises weekly videoconferencing meetings between the patient and the licensed therapist, the patient and the behavioral coach, and the licensed therapist, the behavioral coach, and the supervising consultant.

10. An apparatus for delivering empirically-supported therapy to a patient, the apparatus configured to
receive information from the patient, wherein the information received from the patient relates to a psychotherapeutic condition of the patient,
transmit the information received from the patient to a psychotherapeutic practitioner, wherein the psychotherapeutic practitioner comprises a licensed therapist and a behavioral coach,
receive information from the psychotherapeutic practitioner based on the patient's information, wherein the information received from the psychotherapeutic practitioner comprises a standardized program of empirically-supported therapy treatment over a predetermined period of time,
transmit the information received from the psychotherapeutic practitioner to the patient for delivering empirically-supported therapy to the patient, and
control a plurality of cameras to provide videoconferencing capabilities between the patient, the licensed therapist, and the behavioral coach.

11. A method for delivering empirically-supported therapy to a patient, the method comprising:
receiving information from the patient, wherein the information received from the patient relates to a psychological condition of the patient;
transmitting the information received from the patient to a psychotherapeutic practitioner, wherein the psychotherapeutic practitioner comprises a licensed therapist and a behavioral coach;
receiving information from the psychotherapeutic practitioner based on the patient's information, wherein the information comprises a standardized program of empirically-supported therapy treatment over a predetermined period of time;
transmitting the information received from the psychotherapeutic practitioner to the patient for delivering empirically-supported therapy to the patient; and
controlling a plurality of cameras for providing videoconferencing capabilities between the patient, the licensed therapist, and the behavioral coach.

12. The method of claim 11, further comprising:
storing at least one of the information received from the patient, the information received from the psychotherapeutic practitioner, the standardized program of empirically-supported therapy treatment, a chart of patient information, and a set of notes taken by the psychotherapeutic practitioner.

13. The method of claim 11, wherein the receiving the information from the psychotherapeutic practitioner comprises receiving the standardized program of empirically-supported therapy treatment over a predetermined period of time of no more than twelve weeks.

14. The method of claim 11, wherein the transmitting the information received from the patient comprises transmitting the information to an intake specialist and a supervising consultant.

15. The method of claim 11, wherein the controlling further comprises analyzing a progress of the patient to determine a quality measurement of a performance of the psychotherapeutic practitioner and of an effectiveness of the empirically-supported therapy on the patient.

16. The method of claim 15, wherein the controlling further comprises recommending an adjustment to the performance of the psychotherapeutic practitioner and to the empirically-supported therapy based on the quality measurement for improving the efficacy of the patient's treatment.

17. The method of claim 11, wherein the controlling further comprises distributing the standardized program of empirically-supported therapy treatment that has been manualized to at least one of the patient, the licensed therapist, the behavioral coach, an intake specialist, and a supervising consultant.

18. The method of claim 11, further comprising:
conducting weekly videoconferencing meetings between the patient and the licensed therapist, the patient and the behavioral coach, and the licensed therapist, the behavioral coach, and the supervising consultant.

19. The method of claim 11, determining a suitability of the patient for the standardized program of empirically-supported therapy treatment by the licensed therapist and the behavioral coach based on the information received from the patient.

20. A computer program embodied on a computer readable medium, the computer program being configured to control a processor to perform a process, the process comprising:
receiving information from the patient, wherein the information received from the patient relates to a psychological condition of the patient;
transmitting the information received from the patient to a psychotherapeutic practitioner, wherein the psychotherapeutic practitioner comprises a licensed therapist and a behavioral coach;
receiving information from the psychotherapeutic practitioner based on the patient's information, wherein the information comprises a standardized program of empirically-supported therapy treatment over a predetermined period of time;
transmitting the information received the psychotherapeutic practitioner to the patient for delivering empirically-supported therapy to the patient; and
controlling a plurality of cameras for providing videoconferencing capabilities between the patient, the licensed therapist, and the behavioral coach.
